(19) United States
(12) Patent Application Publication
(10) Pub. No.: US 2023/0269849 A1
(43) Pub. Date: Aug. 24, 2023

(54) METHOD AND SYSTEM FOR ILLUMINATED SPORTS PROJECTILE DEVICE

(71) Applicant: Darren A. Elliott, Toronto (CA)

(72) Inventor: Darren A. Elliott, Toronto (CA)

(21) Appl. No.: 17/675,470

(22) Filed: Feb. 18, 2022

(51) Int. Cl. H05B 47/115; A63B 65/10; A63B 67/14; H05B 45/20

(52) U.S. Cl. CPC H05B 47/115; A63B 65/10; A63B 67/14; H05B 45/20; A63B 2225/74; A63B 2220/40; A63B 2220/53; A63B 2220/833; A63B 2220/62; A63B 2225/50

(57) ABSTRACT

A device and method of illuminating a sports projectile device in motion along a trajectory. The method, performed in a processor device, comprises identifying a transition of the sports projectile device from an inactivated state to an activated state, detecting the motion along the trajectory in accordance with the activated state and illuminating the sports projectile device in accordance with a first periodicity of illumination rendered at a first position along the trajectory.

### TECHNICAL FIELD

The disclosure herein relates to sports projectile devices and methods of operation thereof.

### BACKGROUND

A hockey puck, a device that can be considered in a class of sports projectile devices, is a flat solid black disk-shaped object typically made of vulcanized rubber, and deployed in playing hockey on various surfaces, such as ice ponds and skating rinks, paved roads, synthetic ice surfaces and even hardwood floors in gyms. Frequently, as ambient lighting conditions transition towards dimly lit or darkened, a game being played may need to be terminated, or continued albeit at a slower pace due to lags in player reflexiveness under the less-than-ideal conditions.

### BRIEF DESCRIPTION OF THE DRAWINGS

FIG. 1 illustrates an example embodiment of a sports projectile illumination device and system.

FIG. 2A illustrates, in an example embodiment, a top view of a sports projectile illumination module.

FIG. 2B illustrates, in an example embodiment, a side view of a sports projectile illumination module.

FIG. 3 illustrates, in an embodiment, an example architecture of a sports projectile illumination module.

FIG. 4 illustrates, in an example embodiment, a method of operation of a sports projectile illumination module.

### DETAILED DESCRIPTION

Embodiments herein recognize the need for providing sports projectile devices, including but not limited to hockey pucks and frisbees, with a capability for deployment in dimly lit or darkened conditions. Furthermore, for providing such sports projectile devices with self-contained lighting deployed in accordance with user interface features such that a player or user can intuitively relate to the progression or state of the device as it progresses along its trajectory of motion, to minimize or eliminate undue lags in player reflexive actions and responsiveness.

Among other benefits and technical effects, embodiments herein provide a sports projectile device enabled and suitable for use at night or in low light conditions that projects lights controlled via a self-contained electronics controller module. The electronics controller module (variously referred to herein as controller module) provides light through an arrangement of light emitting diodes (LEDs) that are activated by a motion sensor, controlled by the controller module that triggers the LED lights which in turn illuminate via translucent exterior surface portions of the sports projectile device. In some embodiments, the controller module may be suspended or encased in a generally centered portion of the sports projectile device via translucent substrate materials such as, but not limited to, hot melt or clear epoxy.

Provided is a method of illuminating a sports projectile device in motion along a trajectory. The method performed in a processor includes identifying, by the processor, a transition of the sports projectile device from an inactivated state to an activated state, detecting, by the processor, the motion along the trajectory in accordance with the activated state, and illuminating the sports projectile device in accordance with a first periodicity of illumination rendered at a first position along the trajectory.

Also provided is a sports projectile device having a processor and a non-transitory computer-readable memory including instructions. The instructions, when executed by the processor, cause the processor to perform operations including identifying a transition of the sports projectile device from an inactivated state to an activated state, detecting the motion along the trajectory in accordance with the activated state and illuminating the sports projectile device in accordance with a first periodicity of illumination rendered at a first position along the trajectory.

Embodiments described herein can be implemented using programmatic modules, through the use of instructions that are executable by one or more processors. A programmatic module can include a program, a sub-routine, a portion of a program, or a software component or a hardware component capable of performing one or more stated tasks or functions. As used herein, a programmatic module can exist on a hardware component independently of other modules or components, or can be a shared element of other modules, programs or machines.

One or more embodiments described herein provide that methods, techniques, and actions performed in a sports projectile device and system are performed programmatically, or as a computer-implemented method. Programmatically, as used herein, means through the use of code or computer-executable instructions. These instructions can be stored in one or more memory resources accessible to sports projectile device.

### Device and System

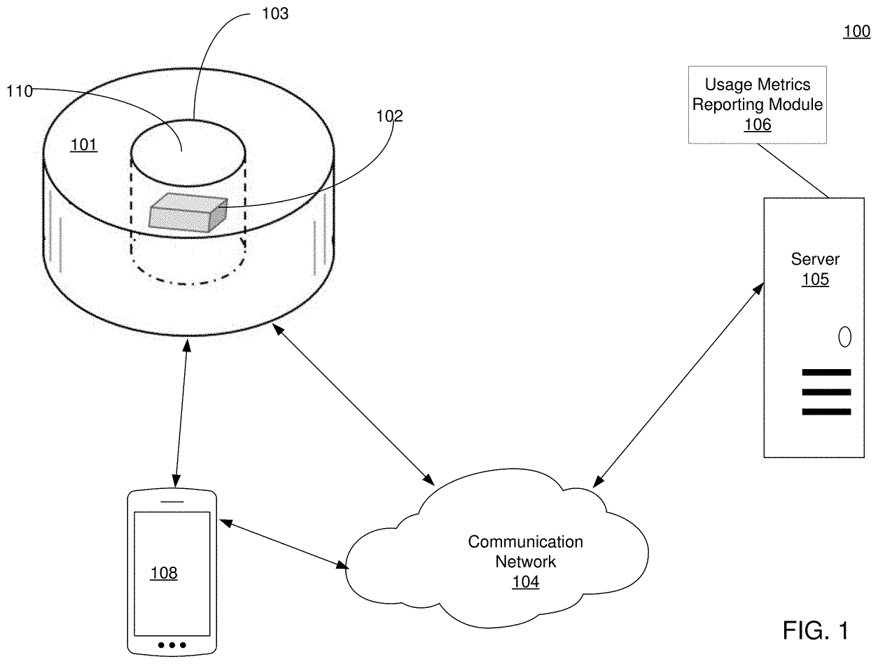

FIG. 1 illustrates an example embodiment of a sports projectile device 101 and system 100. Controller module 102 is at least partially encapsulated within sports projectile device 101. Controller module 102, in embodiments, may be suspended and encased within sports projectile device 101 using substrates such as clear epoxy encasement 110 that also accomplishes LED illumination of one or more external surface portions via illumination widow 103 of sports projectile device 101, or appropriate viscous or semi-solid materials to dampen a degree of impact experienced by controller module 102 in order to protect controller module 102 from mechanical and electrical damage. For instance, in an embodiment where sports projectile device 101 is a hockey puck, the suspensive and encasing substrate dampens or lessens a degree of shock that is transmitted to controller module 102 when the hockey puck is struck, while the clear epoxy encasement around controller module 102 transmits LED illumination to externally visible surface portions, such as illumination window 103 of the hockey puck.

In additional embodiments, usage metrics and reporting module 106 of server 105 within system 100 can acquire data, during or subsequent to a usage session, from controller module 102 of sports projectile device 101. For instance, based on data transmissions from controller module 102 of sports device 101, one or more of user or device account information, geo-location information and timestamp information and details of motion along the trajectories as deployed in playing hockey, for example. In embodiments, server 105 can be maintained at a remotely located provider service or monitoring authority that is communicatively accessible via communications network 104.

In one embodiment, system 100 includes mobile computing device 108, which may be such as a mobile phone device. Sports projectile device 101 is communicatively linked, via wireless communication protocols including, but not limited to, Bluetooth, Wi-Fi, LoRa or RFID. It is contemplated that, in some variations, at least part of the usage metrics and reporting functionality attributed to usage metrics and reporting module 106 of server 105 as described herein can be deployed by way of a software application stored in a memory of mobile computing device 108 for execution thereon. In some embodiments, mobile computing device can communicatively access server 105 via communication network 104.

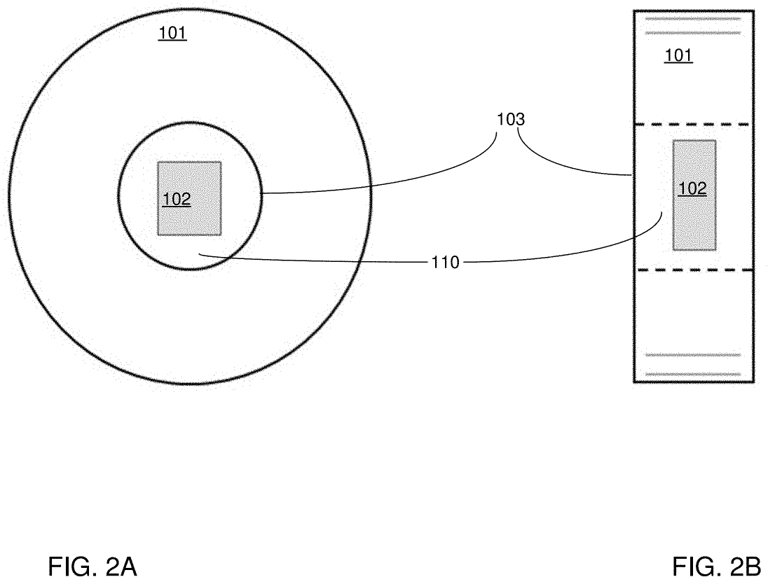

FIG. 2A illustrates, in an example embodiment, a top view of sports projectile device 101 that includes controller module 102, illumination window 103 and clear epoxy encasement 110. In some hockey puck embodiments, clear epoxy encasement 110 comprises a cylindrical cavity that extends from both external playing surfaces (top to bottom) and projects LED illumination through illumination window 103 via LED lights controlled via controller module 102. In one embodiment, the cylindrical cavity is filled with hot melt adhesive also known as hot glue primarily made of ethylene vinyl acetate. It is contemplated that, in some variations, at least some portion of the LED illumination may be displayed or projected via one or more non-playing surfaces, such as a translucent circumferential external surface provided in sports projectile device 101.

FIG. 2B illustrates, in an example embodiment, a side view of sports projectile device 101 that includes controller module 102, illumination window 103 and clear epoxy encasement 110.

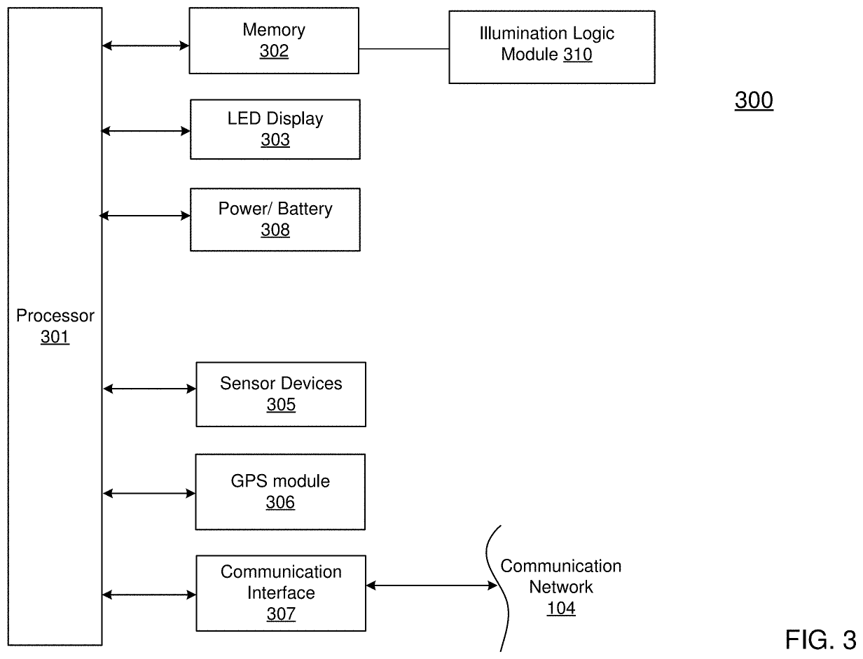

FIG. 3 illustrates, in an embodiment, architecture 300 of controller module 102 that is at least partially encapsulated within sports projectile device 101. Controller module 102, in embodiments, may be suspended and encased within sports projectile device 101 using substrates such as clear epoxy encasement 110 that also allows LED illumination of one or more external surface portions via illumination widow 103 of sports projectile device 101, or appropriate viscous or semi-solid materials to also dampen a degree of impact experienced by controller module 102 in order to protect controller module 102 from mechanical, electrical and environmental damage.

Controller module 102 may include processor 301, memory 302 and LED display 303. Processor 301 can be implemented in an application specific integrated circuit (ASIC) device or a field programmable gate array (FPGA) device, in some embodiments. Memory 302 may be such as, but not limited to, a random-access memory. LED display 303 may be constituted, in some embodiments, of one or more banks of LED lights that include capability for illuminating in accordance with multiple LED colors. In one embodiment, controller module 102 of sports projectile device 101 can include a battery or power source 308 within exterior surfaces of sports projectile device 101. Controller module 102 can also include sensor devices 205, including, but not limited to accelerometer sensors for sensing motion and mechanical impact. The accelerometer sensor as deployed can be mechanical, electrical or based on some combination thereof, but other motion type sensors can be utilized; for example, tilt sensors (ball inside a cylinder), a resistive element (can detect the contact of the device with a hard object—stick or ground for example).

Controller module 102 may also include capability for communicatively accessing wireless communication signals, including but not limited to any of Bluetooth, Wi-Fi, LoRa, RFID, and global positioning system (GPS) signals, and incorporate communication interface 307 for communicatively coupling to communication network 104, such as by sending and receiving cellular and GPS data over data channels. Controller module 102, in some embodiments, can also incorporate GPS module 206 that includes GPS receiver and transmitter circuitry for accessing and enabling transmission of operational metrics associated with deployment of sports projectile device 101. In embodiments, operational metrics can be such as, but not limited to, account information associated with sports projectile device 101, location information, timestamp information and the information regarding motion along the trajectory in usage or deployment instances and periods for sports projectile device 101.

Controller module 102 can include a light emitting diode (LED) display 303 consisting of one or more banks or rows of LEDs, capable of rendering illumination in accordance with one or more colors. As referred to herein, the LED-based illuminating is rendered in accordance with one or more LED lights of an LED bank of lights being disposed within an at least partially translucent surface of sports projectile device 101. Illumination logic module 310 of controller module 102, in embodiments, can be constituted of computer processor-executable code stored in memory 302 that are executable in processor 301, to accomplish illumination functionality as described herein, associated with usage or deployments of sports projectile device 101. In one embodiment, the software instructions or programs, including any updates thereof, constituting illumination logic module 310 can be downloaded to memory 202 by accessing and downloading, via communication network 104, from a remote server computing device, including from server 105, or from mobile computing device 108 via wireless communication protocols as described herein. Controller module 102, in an embodiment, includes an integrated circuit device that controls an internal timer clock driving the durations and periodicity in which the LED lights are displayed.

Illumination logic module 310 of controller module 102, in embodiments, also includes executable instructions to identify a transition of the sports projectile device from an inactivated (off) state to an activated (on) state. In one embodiment, processor 301 identifies the transition from inactivated state to activated state based on detecting, in conjunction with an accelerometer sensor device, a shock enacted upon the sports projectile device that exceeds some predetermined threshold value of shock, the shock being generated, for example, when a user taps sports projectile device 101 against a solid or semi-solid surface.

Illumination logic module 310 of controller module 102, in embodiments, also includes executable instructions to detect motion of sports projectile device 101 along its trajectory of motion. In one embodiment, detecting the motion is performed in accordance with an accelerometer sensor device disposed within the sports projectile device 101, the accelerometer sensor being in electrical communication with controller module 102.

Illumination logic module 310 of controller module 102, in embodiments, also includes executable instructions to cause, using the processor, illuminating the sports projectile device in accordance with a first periodicity of illumination rendered at a first position along the trajectory and a second periodicity of illumination rendered at a second position along the trajectory. The term periodicity as used herein refers to a frequency of alternation between lit (on) and unlit (off) states of LED illumination. In another embodiment, the frequency of alternation may be between lit states of a first color and a second color of LED illumination. In some embodiments, when controller module 120 activates (turns on) the LED lights they enter an illumination cycle having a periodicity in accordance with slow overlapping pulsing flashing lights on each side of the puck. In other embodiments, other external surfaces of the puck may be translucent to render the illumination for visibility to a player or user. In one embodiment, assuming there are 2 led lights on each side of the controller module (top and bottom) they will flash (turn on and off with approximately a 2 second cycle (which duration can be varied) with an overlap of about 25% so the LED illumination is always on and visible to a player when in the activated state.

### Methodology

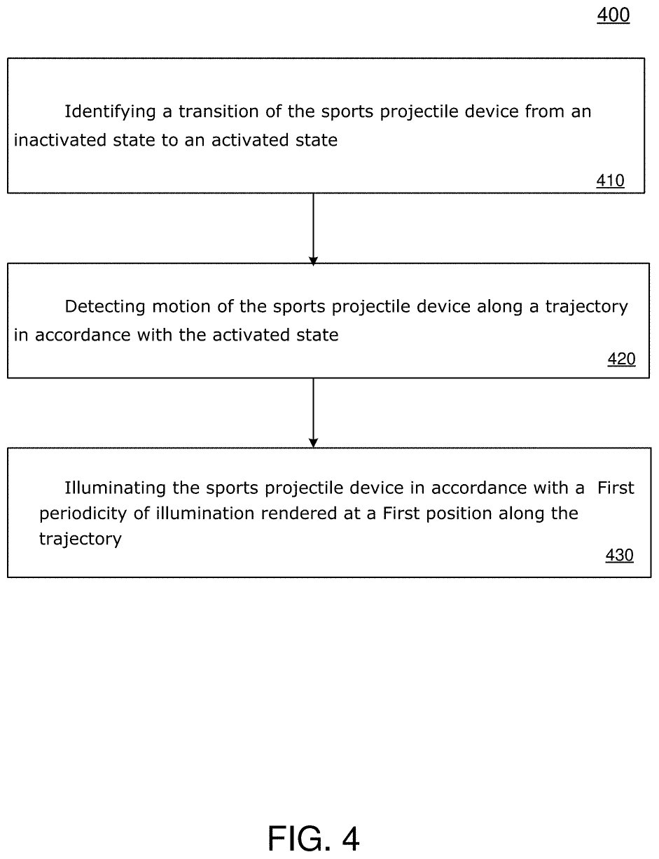

FIG. 4 illustrates, in an example embodiment, method 400 of operation in sports projectile device 101. Examples of method steps described herein are related to deployment and use of sports projectile device 101 as described herein. According to one embodiment, the techniques are performed in processor 301 executing one or more sequences of software logic instructions that constitute illumination logic module 310 of controller module 102. In embodiments, instructions constituting illumination logic module 310 may be read into memory 302 from machine-readable medium, such as memory storage devices. Executing the instructions of illumination logic module 310 stored in memory 302 causes processor 301 to perform the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions.

At step 410, identifying, by the processor 301, a transition of sports projectile device 101 from an inactivated state to an activated state. In some example embodiments, sports projectile device 101 may be a hockey puck or a frisbee. In an embodiment, the transition from an inactivated state to an activated state can be based on a motion sensor, such as an accelerometer sensor device of sensor devices 305.

In one embodiment, processor 301 identifies the transition from inactivated state to activated state based on based on detecting, in conjunction with an accelerometer sensor device, a shock enacted upon sports projectile device 101 that exceeds some predetermined threshold value of shock, the shock being generated, for example, when a user taps the sports projectile device against a solid or semi-solid surface.

At step 420, detecting, by the processor 301 in conjunction with sensor devices 305, the motion along the trajectory in accordance with the activated state. In one embodiment, detecting the motion is performed in accordance with an accelerometer sensor device disposed within sports projectile device 101 that is communicatively accessible to controller module 102.

At step 430, illuminating the sports projectile device 101 in accordance with a first periodicity of illumination rendered at a first position along the trajectory. In some embodiments, the illuminating is rendered in accordance with one or more LED lights disposed within an at least partially translucent surface of sports projectile device 101. In a variation, controller module 102 may transition to a second periodicity of illumination, rendered at a second position as sports projectile device 101 progresses along its trajectory of motion. In an embodiment, the first periodicity comprises a higher frequency of alternating between a first state of illumination and a second state of illumination as compared with the second periodicity. In another variation, the first state of illumination comprises a first illumination color, and the second state of illumination comprises one of (i) a second illumination color and (ii) a non-illuminated state. In yet another variation, the first periodicity comprises a lesser frequency of alternating between the first state of illumination and the second state of illumination as compared with the second periodicity.

In some embodiments, when controller module 120 activates (turns on) the LED lights they enter an illumination cycle having a periodicity in accordance with slow overlapping pulsing flashing lights on each side of the puck. In other embodiments, other external surfaces of the puck may be translucent to render the illumination for visibility to a player or user. In one embodiment, assuming there are 2 led lights on each side of the controller module (top and bottom) they will flash (turn on and off with approximately a 2 second cycle (which duration can be varied) with an overlap of about 25% so the LED illumination is always on and visible to a player when in the activated state.

In embodiments, the intensity of the LED illumination may be varied along the trajectory of motion of sports projectile device 101. In one embodiment, the intensity of the LED illumination may be progressively increased as sports projectile device 101 progressively advances along at least a portion of its trajectory of motion. In another embodiment, the intensity of the LED illumination may be progressively decreased as sports projectile device 101 progressively advances along at least a portion of its trajectory of motion.

The method of operation, in one embodiment, can include detecting a cessation of the motion of sports projectile device 101 along its trajectory, and terminating the illuminating within a predetermined period upon detecting the cessation of motion.

In some embodiments, if the motion activated sensor is triggered again while the internal timer clock of controller module 102 is still counting down (any time from 60 seconds to 1 second) the internal timer clock is reset back to its starting position (60 seconds) and resumes counting down. This results in the lights continuing to stay on (activated) until the internal timer clock hits 0 seconds during countdown, or is reset again there by once again extending the lights on (activated) time. It is contemplated that other values for the countdown timer, lesser or greater than 60 seconds, can be applied in regard to the internal timer clock.

In yet another variation, the method can include transmitting, to a computing device such as a remote server computing device, one or more of account information, location information and timestamp information associated with sports projectile device 101 and details of is motion along the trajectory upon detecting the cessation of motion.

Although embodiments are described in detail herein with reference to the accompanying drawings, it is contemplated that the disclosure herein is not limited to only such literal embodiments. As such, many modifications including variations in sequence of the method steps in conjunction with varying combinations of user interface features disclosed herein will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments. Thus, the absence of describing combinations of such do not preclude the inventor from claiming rights to such combinations.

What is claimed is:

1. A method of illuminating a sports projectile device in motion along a trajectory, the method performed in a processor and comprising:
identifying, by the processor, a transition of the sports projectile device from an inactivated state to an activated state;
detecting, by the processor, the motion along the trajectory in accordance with the activated state; and
illuminating the sports projectile device in accordance with a first periodicity of illumination rendered at a first position along the trajectory.

2. The method of claim 1 wherein the sports projectile device comprises one of a hockey puck and a frisbee.

3. The method of claim 1 further comprising illuminating the sports projectile device in accordance with a second periodicity of illumination rendered at a second position as the sports projectile device progresses in motion along the trajectory, wherein the first periodicity comprises a higher frequency of alternating between a first state of illumination and a second state of illumination than the at least a second periodicity.

4. The method of claim 3 wherein the first state of illumination comprises a first illumination color, and the second state of illumination comprises one of (i) a second illumination color and (ii) a non-illuminated state.

5. The method of claim 3 wherein the first periodicity comprises a lesser frequency of alternating between a first state of illumination and a second state of illumination than the at least a second periodicity.

6. The method of claim 1 further comprising identifying the transition in accordance with detecting, in conjunction with an accelerometer sensor device, a shock enacted upon the sports projectile device that exceeds a predetermined threshold value.

7. The method of claim 1 further comprising detecting the motion in accordance with an accelerometer sensor device disposed within the sports projectile device.

8. The method of claim 1 wherein the illuminating is rendered in accordance with one or more LED lights disposed within an at least partially translucent surface of the sports projectile device.

9. The method of claim 1 further comprising:
detecting a cessation of the motion along the trajectory; and
terminating, within a predetermined period upon detecting the cessation, the illuminating.

10. The method of claim 9 further comprising:
transmitting, to a computing device, one or more of account information, location information and timestamp information associated with the sports projectile device and the motion along the trajectory upon detecting the cessation.

11. A sports projectile device comprising:
a processor; and
a non-transitory memory including instructions, the instructions when executed by the processor causing the processor to perform operations comprising:
identifying, by the processor, a transition of the sports projectile device from an inactivated state to an activated state;
detecting, by the processor, the motion along the trajectory in accordance with the activated state; and
illuminating the sports projectile device in accordance with a first periodicity of illumination rendered at a first position along the trajectory.

12. The sports projectile device of claim 11 wherein the sports projectile device comprises one of a hockey puck and a frisbee.

13. The sports projectile device of claim 11 further comprising instructions executable for illuminating the sports projectile device in accordance with a second periodicity of illumination rendered at a second position as the sports projectile device progresses in motion along the trajectory, wherein the first periodicity comprises a higher frequency of alternating between a first state of illumination and a second state of illumination than the at least a second periodicity.

14. The sports projectile device of claim 13 wherein the first state of illumination comprises a first illumination color, and the second state of illumination comprises one of (i) a second illumination color and (ii) a non-illuminated state.

15. The sports projectile device of claim 13 wherein the first periodicity comprises a lesser frequency of alternating between a first state of illumination and a second state of illumination than the at least a second periodicity.

16. The sports projectile device of claim 11 further comprising instructions executable in the processor for identifying the transition in accordance with detecting, in conjunction with an accelerometer sensor device, a shock enacted upon the sports projectile device that exceeds a predetermined threshold value.

17. The sports projectile device of claim 11 further comprising instructions executable in the processor for detecting the motion in accordance with an accelerometer sensor device disposed within the sports projectile device.

18. The sports projectile device of claim 11 wherein the illuminating is rendered in accordance with one or more LED lights disposed within an at least partially translucent surface of the sports projectile device.

19. The sports projectile device of claim 11 further comprising instructions executable in the processor to cause:
detecting a cessation of the motion along the trajectory; and
terminating, within a predetermined period upon detecting the cessation, the illuminating.

20. The sports projectile device of claim 19 further comprising instructions executable in the processor to cause:
transmitting, to a computing device, one or more of account information, location information and timestamp information associated with the sports projectile device and the motion along the trajectory upon detecting the cessation.
